(19) United States
(12) Patent Application Publication
(10) Pub. No.: US 2010/0305226 A1
(43) Pub. Date: Dec. 2, 2010

(54) POLYURETHANE FOAM CONTAINING SILICONE

(75) Inventors: Jens Cremer, Munich (DE); Klaus Stowischek, Munich (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/599,195

(22) PCT Filed: Jun. 9, 2008
(86) PCT No.: PCT/EP2008/057159

§ 371 Date: Nov. 6, 2009

(30) Foreign Application Priority Data
Jun. 20, 2007 (DE) 10 2007 028 253.4

(51) Int. Cl. C08J 9/06

(52) U.S. Cl. 521/99

(57) ABSTRACT

Silicone-containing polyurethane foams prepared from isocyanate-containing organosilicon compounds and expandable graphite are flame retardant without displaying liquifaction of the polymer component when the foam is exposed to high temperatures.

The invention relates to foamable compositions based on organosilicon compounds that comprise expandable graphite, to silicone-containing polyurethane foams, and to processes for their preparation.

Polyurethane foams are already known. A major problem of polyurethane foams (PU foams) is their inherent combustibility. Consequently there has been no lack of attempts in recent decades to improve the flame retardance properties of polymer foams. As well as the addition of halogen-containing or phosphorus-containing flame retardants, a multiplicity of inorganic fillers, such as aluminum trihydroxide, for example, have also been incorporated into the polymer matrix of the foams.

Another technique of flame-retarding PU foams is the use of expandable graphite, which, on increasing its volume under the action of heat, seals the surface and thus greatly retards the processes of combustion of the polymer matrix beneath. In this regard reference may be made, for example, to U.S. Pat. No. 4,698,369. A disadvantage, however, is that usually considerable amounts of the expandable graphite are needed in order to produce a relatively flame-retarded PU foam, thereby significantly impairing its mechanical properties. Furthermore, it is only possible in this way to obtain a flame-retarded PU foam, and never a completely incombustible PU foam.

An entirely different route to incombustible, flexible PU foams is taken with the silicone-polyurethane flexible foams. In such foams, for example, the highly combustible polyol component that is used in standard PU foams is replaced by incombustible, OH-terminated siloxanes.

Through the use of silicone-polyurethane copolymers, i.e., of polysiloxanes, which also contain polyurethane units and/or urea units, it is possible to develop incombustible foam materials of this kind which have new combinations of properties that are tailored precisely to the particular application.

DE-A 41 08 326 describes silicone foams which can be prepared by reacting hydroxyalkyl-functional polysiloxanes with diisocyanates or polyisocyanates. WO-A 03/080696 describes silicone foams which are preparable from particular hydroxyalkyl- and/or aminoalkyl-functional polysiloxanes with diisocyanates or polyisocyanates.

Although all of the silicone-polyurethane foams obtained in this way have the common feature of incombustibility, they nevertheless tend toward severe dripping on exposure to heat.

The invention provides foamable compositions comprising (A) organopolysiloxane having at least one isocyanate group and (B) expandable graphite.

For the purposes of the present invention the term “organopolysiloxanes” is intended to embrace polymeric, oligomeric, and dimeric siloxanes.

The siloxanes (A) used in accordance with the invention are preferably those comprising units of the formula

RₐR¹_{b}(R²O)ₒSiO_{4-a-b-c/2} (I)

where

R can be identical or different and is a monovalent, SiC-bonded, optionally substituted hydrocarbon radical which may be interrupted by oxygen atoms,

R¹ can be identical or different and is a monovalent, optionally substituted hydrocarbon radical having at least one isocyanate group, and may be interrupted by heteroatoms,

R² can be identical or different and is a monovalent, optionally substituted hydrocarbon radical which may be interrupted by heteoratoms,

a is 0, 1, 2 or 3,

b is 0, 1, 2 or 3, and

c is 0, 1, 2 or 3,

with the proviso that the sum a+b+c≦3 and there is at least one unit with b other than 0 present.

Examples of R are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical; alkenyl radicals, such as the vinyl and the allyl radical; cycloalkyl radicals, such as cyclopentyl, cyclohexyl, cycloheptyl radicals and methylcyclohexyl radicals; aryl radicals, such as the phenyl and the naphthyl radical; alkaryl radicals, such as o-, m-, p-tolyl radicals, xylyl radicals, and ethylphenyl radicals; aralkyl radicals, such as the benzyl radical, the α- and the β-phenylethyl radical.

Preferably radical R comprises monovalent, optionally substituted hydrocarbon radicals having 1 to 40 carbon atoms, more preferably hydrocarbon radicals having 1 to 30 carbon atoms, more particularly hydrocarbon radicals having 1 to 6 carbon atoms.

Radical R¹ preferably comprises those of the formula

—Y-A-C(O)—NH—Z—NCO (II)

where

Y and Z independently of one another are divalent, optionally substituted hydrocarbon radicals which may be interrupted by heteroatoms and

A has the definition of —O— or —NR³—, where R³ is hydrogen atom or monovalent, optionally substituted hydrocarbon radical.

Preferably radical R³ is hydrogen atom.

Preferably radical A is the radical —NR³—, where R³ is as defined above.

Preferably Y comprises divalent, aliphatic, optionally —NCO-substituted hydrocarbon radicals, more preferably propylene and methyloxyethylene radicals, more particularly propylene radicals.

Preferably Z comprises divalent, aromatic, optionally —NCO-substituted hydrocarbon radicals, more preferably toluenylene and methylene-bis-phenylene radicals, more particularly toluenylene radicals.

Examples of radical R² are the examples specified for radical R.

The value of a is preferably 2.

The value of b is preferably 0 or 1.

The value of c is preferably 0.

The siloxanes (A) used in accordance with the invention are preferably branched and linear siloxanes, more particularly substantially linear siloxanes.

The siloxanes (A) are more preferably those which are composed of units of the formula (I).

The siloxanes (A) used in accordance with the invention have an isocyanate content of preferably 0.1% to 20% by weight, more preferably 0.1% to 10% by weight.

The siloxanes (A) used in accordance with the invention have a viscosity of preferably 10 to 10 000 mPas, more preferably 50 to 500 mPas, in each case at 25° C.

The siloxanes (A) used in accordance with the invention are commercial products and/or can be prepared by processes which are commonplace in silicon chemistry.

The siloxanes (A) used in accordance with the invention are prepared preferably by reacting α,ω-aminoalkyl-functionalized and/or α,ω-hydroxy-functionalized siloxanes (A1) with polyisocyanates.

In the reaction of the siloxanes (A1) with the polyisocyanates, the polyisocyanates are used preferably in an excess, such that per mole of aminoalkyl radicals and/or hydroxy-functional radicals of the organopolysiloxanes (A1) at least 1 mol, more particularly 2 to 10 mol, of isocyanate units are used. The molar excess of isocyanates is preferably consumed in the course of foam formation for the reaction with water.

Expandable graphite for the purposes of the present invention is graphite which comprises one or more expandants. Expandable graphite is produced by methods which are known in the art. In general, graphite is first modified with oxidizing agents, such as nitrates, chromates, peroxides, for instance, or modified by electrolysis, in order to open the crystal layer, and then nitrates or sulfates are introduced or intercalated within the graphite. Under the action of heat, the layers of the expandable graphite are driven apart by thermolysis. The temperature at which expansion begins is termed the starting temperature and is dependent on the variety of expandable graphite. The increase in volume on exposure to heat is termed the expansion rate and is dependent not only on the variety of expandable graphite but also on the exposure temperature, and, in general, increases as the temperature goes up.

The expandable graphite (B) used in accordance with the invention has an expansion rate of preferably 50 to 500 cm³/g, more preferably 100 to 400 cm³/g, in each case at 1000° C.

The expandable graphite (B) used in accordance with the invention has a starting temperature in the range from preferably 150 to 300° C., more preferably 180 to 250° C.

The expandable graphite (B) used in accordance with the invention has a carbon content of preferably 85% to 99.9% by weight, in particular of 90% to 99.9% by weight, more particularly of 95% to 99% by weight.

The expandable graphite (B) used in accordance with the invention has a particle size of preferably 0.05 to 0.3 mm, more preferably 0.1 to 0.25 mm.

The expandable graphite (B) used in accordance with the invention has an ash value of preferably 0.01% to 5% by weight, more preferably 0.1% to 2% by weight.

The expandable graphite (B) used in accordance with the invention has a moisture content of preferably 0.01% to 2% by weight, more preferably 0.1% to 1% by weight.

The compositions of the invention comprise expandable graphite (B) in amounts from preferably 0.1 to 50 parts by weight, more preferably 0.1 to 25 parts by weight, more particularly 0.1 to 15 parts by weight, based in each case on 100 parts by weight of siloxane (A).

Further to the siloxanes (A) and expandable graphite (B), the compositions of the invention may comprise additional substances, such as, for example, isocyanates (C), fillers (D), emulsifiers (E), physical blowing agents (F), catalysts (G), chemical blowing agents (H), and additives (I).

As optionally used isocyanates (C) it is possible to use all known diisocyanates or polyisocyanates.

Preference is given to using polyisocyanates (C) of the general formula

Q(NCO)ₙ (III)

where
Q is an n-functional, optionally substituted hydrocarbon radical and
n is an integer of at least 2, preferably from 2 to 10, more preferably 2 or 3, more particularly 2.

Preferably Q comprises optionally substituted hydrocarbon radicals having 4 to 30 carbon atoms, more preferably hydrocarbon radicals having 6 to 15 carbon atoms.

Examples of diisocyanates (C) are diisocyanatodiphenyl-methane (MDI), not only in the form of crude or technical MDI but also in the form of pure 4,4′ and/or 2,4′ isomers or compositions thereof, tolylene diisocyanate (TDI) in the form of its various regioisomers, diisocyanatonaphthalene (NDI), isophorone diisocyanate (IPDI), 1,3-bis(1-isocyanato-1-methylethyl)benzene (TMXDI) or else hexamethylene diisocyanate (HDI). Examples of polyisocyanates (C) are polymeric MDI (p-MDI), triphenylmethane triisocyanate or biuret trimers or isocyanurate trimers of the abovementioned isocyanates. The diisocyanates and/or polyisocyanates (C) may be used alone or in a mixture.

With particular preference the optionally used isocyanates (C) are those of the formula

OCN—Z′—NCO (IV)

where Z′ has a definition specified above for Z.

More particularly the isocyanates (C) are the same ones used in preparing the siloxanes (A). In that case, if desired, isocyanate may be used in excess in the preparation of the siloxanes (A), and the resulting mixture may advantageously be used further for preparing the composition of the invention.

Where the compositions of the invention comprise isocyanates (C), the amounts in question are preferably 0.1 to 50 parts by weight, more preferably 0.1 to 40 parts by weight, more particularly 0.1 to 30 parts by weight, based in each case on 100 parts by weight of siloxane (A).

The compositions of the invention preferably comprise isocyanates (C).

If fillers (D) are used, the fillers in question may be all nonreinforcing fillers, i.e., fillers having a BET surface area of up to 50 m²/g, such as chalk, or reinforcing fillers, i.e., fillers having a BET surface area of at least 50 m²/g, such as carbon black, precipitated silica or fumed silica. In particular both hydrophobic and hydrophilic fumed silicas represent a preferred filler. One particularly preferred embodiment of the invention uses a hydrophobic fumed silica whose surface has been modified with trimethylsilyl groups. The fillers (D) that are used—more particularly fumed silicas—may take on a variety of functions. Thus they may be used to adjust the viscosity of the foamable mixture. In particular, however, they are able to take on a “support function” in the course of foaming, and thus lead to foams having a better foam structure. Finally, the mechanical properties of the resultant foams may also be decisively improved through the use of fillers (D)—especially through the use of fumed silica.

If the compositions of the invention comprise fillers (D), the amounts in question are preferably 0.1 to 30 parts by weight, more preferably 0.1 to 20 parts by weight, more particularly 0.1 to 15 parts by weight, based in each case on 100 parts by weight of siloxane (A).

The compositions of the invention preferably comprise fillers (D).

In many cases it is of advantage to add emulsifiers (E) to the foamable compositions. As suitable emulsifiers (E), which also serve as foam stabilizers, it is possible, for example, to use all commercial silicone oligomers that are modified with polyether side chains and that are also used in producing conventional polyurethane foams.

If emulsifiers (E) are used, the amounts in question are preferably up to 6% by weight, more preferably from 0.3% to 3% by weight, based in each case on the total weight of the foamable compositions.

The compositions of the invention preferably comprise emulsifiers (E).

Moreover, the compositions may also comprise compounds (F) which are able to act as physical blowing agents. As constituent (F) it is preferred to use low molecular mass hydrocarbons such as, for example, propane, butane or cyclopentane, dimethyl ether, fluorinated hydrocarbons such as 1,1-difluoroethane or 1,1,1,2-tetrafluoroethane or CO₂. In this case the production of foam may if desired take place exclusively by means of the physical blowing agents (F). Usually, however, the formation of foam takes place primarily through a reaction of the isocyanate-functional siloxanes with the chemical blowing agent component (H). Even in that case, though, the use of physical blowing agents (F) in combination with chemical blowing agent constituent (H) may be advantageous, in order thus to obtain foams having a relatively low density.

If the compositions of the invention comprise constituent (F), the amounts in question are from preferably 0.1 to 30 parts by weight, more preferably 0.1 to 20 parts by weight, more particularly 0.1 to 15 parts by weight, based in each case on 100 parts by weight of siloxane (A).

The compositions of the invention preferably comprise no physical blowing agent (F).

Furthermore, the foamable compositions of the invention may comprise catalysts (G) which accelerate the curing of the foam. Suitable catalysts (G) include organotin compounds. Examples are dibutyltin dilaurate, dioctyltin dilaurate, dibutyltin diacetate, dibutyltin dioctoate or dibutyltin bis(dodecylmercaptide). Moreover, tin-free catalysts (G) are contemplated as well, examples being organic titanates, iron catalysts, such as organic iron compounds, organic and inorganic heavy-metal compounds or amines. An example of an organic iron compound is iron(III) acetylacetonate. Examples of amines are triethylamine, tributylamine, 1,4-diazabicyclo[2.2.2]octane, N,N-bis(N,N-dimethyl-2-aminoethyl)methylamine, N,N-dimethylcyclohexylamine, N,N-dimethylphenylamine, bis-N,N-dimethylaminoethyl ether, N,N-dimethyl-2-aminoethanol, N,N-dimethylamino-pyridine, N,N,N,N-tetramethylbis(2-aminoethyl)methyl-amine, 1,5-diazabicyclo[4.3.0]non-5-ene, 1,8-diaza-bicyclo[5.4.0]undec-7-ene, N-ethylmorpholine or N,N′-dimethylaminopyridine.

The catalysts (G) may be used individually or as mixture. If desired, the catalysts used in the preparation of the siloxanes (A) may also serve simultaneously as catalysts (G) for foam curing.

If catalyst (G) is used, the amounts in question are from preferably 0.1% to 6.0% by weight, more preferably from 0.3% to 4.0% by weight, based in each case on the total weight of the foamable composition of the invention.

The compositions of the invention preferably comprise catalysts (G).

As chemical blowing agents (H) it is possible in principle for not only water but also all compounds having preferably at least one isocyanate-reactive function to be used.

Examples of constituent (H) are aminoalkyl- or hydroxy-functional siloxanes (A1), monomeric alcohols, monomeric diols such as glycol, propanediol, butane-diol, monomeric oligools such as pentaerythritol or trihydroxymethylethane, oligomeric or polymeric alcohols having one, two or more hydroxyl groups such as ethylene glycols or propylene glycols, water, monomeric amines having one, two or more amine functions such as ethylenediamine, hexamethylene-diamine, and also oligomeric or polymeric amines having one, two or more amine functions.

If constituent (H) is used, it preferably comprises hydroxy compounds, with water being particularly preferred.

The compositions of the invention preferably comprise constituent (H).

The compositions of the invention comprise constituent (H) in amounts of preferably 0.1 to 20 parts by weight, more preferably from 0.1 to 15 parts by weight, more particularly from 0.1 to 10 parts by weight, based in each case on 100 parts by weight of siloxane (A).

As additives (I), furthermore, the addition of cell regulators, thixotropic agents and/or plasticizers may also be advantageous. In order to improve further the fire resistance, moreover, flame retardants may be added to the foamable compositions, examples being phosphorus-containing compounds, especially phosphates and phosphonates, and also halogenated polyesters and polyols or chlorinated paraffins.

If additives (I) are used, the amounts involved are from preferably 0.1 to 30 parts by weight, more preferably from 0.1 to 20 parts by weight, more particularly from 0.1 to 15 parts by weight, based in each case on 100 parts by weight of siloxane (A).

The compositions of the invention preferably comprise no additives (I).

With regard to the components used in accordance with the invention, the components in question may in each case be one kind of such a component or else a mixture of at least two kinds of a respective component.

Preferably the compositions of the invention are those comprising

(A) siloxanes comprising units of the formula (I),

(B) expandable graphite,

optionally

(C) isocyanates,

optionally

(D) fillers,

optionally

(E) emulsifiers,

optionally

(F) physical blowing agents,

optionally

(G) catalysts,

(H) chemical blowing agents, and

optionally

(I) additives.

Aside from components (A), (B), and, optionally, one or more of components (C) to (I), the compositions of the invention preferably comprise no further constituents.

The compositions of the invention can be prepared by any desired processes known per se, such as simple mixing, in which case premixes of individual constituents may also be prepared. Both 1-component systems and 2-component systems may be prepared.

Where the compositions of the invention are provided in the form of 2-component systems, which is preferred, the two components of the foamable composition of the invention may comprise all of the constituents in any desired combinations and proportions, with the proviso that one component does not simultaneously comprise constituents (A) and (H).

Thus, for example, to prepare the composition of the invention, preferably a mixture comprising constituent (A), constituent (B), optionally constituent (C), optionally constituent (D), optionally constituent (F), and optionally constituent (I) is prepared, as component 1, and also a component 2 comprising constituent (H), optionally constituent (E), and optionally constituent (G), which are then mixed with one another to produce the foam of the invention.

It is, however, also possible—if desired—to prepare the composition of the invention by mixing all of the constituents with one another in one step. In these 1-component systems the foam is then formed preferably by using a physical blowing agent (F). After the foam has been applied it then cures by reaction with atmospheric moisture.

The compositions of the invention are preferably liquid to highly viscous and have a viscosity of preferably 500 to 20 000 mPas, more preferably 1000 to 10 000 mPas.

The compositions of the invention serve preferably for the production of foams, more preferably of rigid foams or flexible foams, more particularly of flexible foams.

The present invention further provides a process for preparing silicone-containing polyurethane foams, characterized in that organopolysiloxane having at least one isocyanate group (A) is mixed with expandable graphite (B) and chemical blowing agent (H) and caused to react.

In one preferred embodiment of the process of the invention, organopolysiloxane having at least one isocyanate group (A), expandable graphite (B), catalyst (G), and chemical blowing agent (H) are mixed and caused to react.

The process of the invention is carried out at temperatures of preferably 0 to 100° C., more preferably 10 to 40° C., more particularly 15 to 30° C.

The process of the invention is carried out preferably under the pressure of the surrounding atmosphere, in other words about 900 to 1100 hPa.

The process of the invention releases preferably CO₂ which is largely responsible for the development of the foam structure according to the invention.

The present invention further provides silicone-containing polyurethane foams comprising expandable graphite (B).

The foams of the invention comprise expandable graphite in amounts from preferably 0.05% to 30% by weight, more preferably from 0.1% to 20% by weight, more particularly from 0.1% to 15% by weight, based in each case on the total weight of the foam.

The foams of the invention are notable for a fine, open-cell foam structure. Their mechanical properties match those of PU foams available commercially.

The foams of the invention have a density of preferably 50 to 500 kg/m³, more preferably 50 to 200 kg/m³, more particularly 50 to 120 kg/m³.

The foams of the invention can be used everywhere polyurethane foams have been used to date. More particularly they are suitable for upholstery, thermal insulation, and sound insulation.

The foamable compositions of the invention have the advantage that they can be processed in a very simple way and using the techniques known to date from PU technology.

Furthermore, the compositions of the invention have the advantage that they can be prepared with starting materials that are readily available commercially.

The compositions of the invention have the advantage, moreover, that they are easy to process and can be prepared at low viscosity.

The process of the invention for preparing silicone-containing PU foams has the advantage that it is easy to carry out.

The foams of the invention have the advantage that they exhibit no tendency toward dripping under extreme heat exposure.

The foams of the invention have the advantage, furthermore, that they are of extremely low flammability.

The foams of the invention have the advantage that the incorporation of only small amounts of the expandable graphite into the polymer matrix of the silicone-PU foam binds the polymer component which is liquefied in the course of exposure to heat, at temperatures above 140° C., for example, and thus prevents dripping of the foam.

In the examples below, all parts and percentage data, unless indicated otherwise, are by weight. Unless indicated otherwise, the examples below are carried out under the pressure of the surrounding atmosphere, in other words at about 1000 hPa, and at room temperature, in other words about 20° C., or at a temperature which comes about when the reactants are combined at room temperature without additional heating or cooling. All of the viscosity data given in the examples are intended to be based on a temperature of 25° C.

### COMPARATIVE EXAMPLE 1

### Preparation of Premix 1

50.00 g of a linear organopolysiloxane of the formula H₂N—(CH₂)₃—[(CH₃)₂—SiO]₁₂₉Si(CH₃)_{2—(CH}₂)₃—NH₂, in solution in a mixture of 25 ml of absolute acetone and 25 ml absolute dichloromethane, were added slowly dropwise to a solution of tolylene diisocyanate (TDI) (4.3 g in 20 ml of absolute acetone) and thus reacted at 0° C., the amino groups being fully consumed by reaction. The resulting reaction mixture, which in addition to 51.7 g of isocyanatosiloxane OCN—(CH₂)₃—[(CH₃)₂—SiO]₁₂₉Si(CH₃)₂—(CH₂)₃—NCO also contains 2,6 TDI, was then warmed to room temperature and freed from the solvent under a pressure of 10 mbar.

10.00 g of the resultant premix 1 were admixed with 0.16 g of bis(2-dimethylaminoethyl)ether (commercially available under the name “Jeffcat® ZF-20” from Huntsman Corp., D-Hamburg) as catalyst and 0.15 g of emulsifier (commercially available under the name Belsil® DMC 3071VP from Wacker Chemie AG, D-Munich). The resulting mixture was first processed to a homogeneous emulsion, using a high-speed KPG stirrer. Then 0.14 g of water was added rapidly and emulsification took place again, to form a homogeneous mixture, using a high-speed KPG stirrer. After about 5 seconds, an exothermic reaction with development of foam began. Foam formation was over after approximately 20 seconds more, while the evolution of heat lasted for approximately 30 seconds more. The result was a colorless, flexible, incombustible foam which had a tendency to drip severely in the flame from a Bunsen burner. It was observed that, at the point where it was struck by the Bunsen burner flame, the flexible foam liquefied immediately, and the low-viscosity silicone material thus formed at that point dripped directly to the ground.

### INVENTIVE EXAMPLE 1

### Preparation of Premix 2

50.00 g of a linear organopolysiloxane of the formula H₂N—(CH₂)₃—[(CH₃) ₂—SiO]₁₂₉Si(CH₃)₂—(CH₂)₃—NH₂, in solution in a mixture of 25 ml of absolute acetone and 25 ml absolute dichloromethane, were added slowly dropwise to a solution of tolylene diisocyanate (TDI) (4.3 g in 20 ml of absolute acetone) and thus reacted at 0° C., the amino groups being fully consumed by reaction. The resulting reaction mixture, which in addition to 51.7 g of isocyanatosiloxane OCN—(CH₂)₃—[(CH₃)₂—SiO]₁₂₉Si(CH₃)₂—(CH₂)₃—NCO also contains 2,6 TDI, was then warmed to room temperature and stirred for a further two hours, before 4.9 g of an expandable graphite (commercially available under the name “EX-EF-80 SC” from NGS Naturgraphit GmbH, D-Leinburg) were dispersed into the solution. Subsequently premix 2 was freed from the solvent under a pressure of 10 mbar.

10.00 g of the resultant premix 2 were admixed with 0.16 g of bis(2-dimethylaminoethyl)ether (commercially available under the name “Jeffcat® ZF-20” from Huntsman Corp., D-Hamburg) as catalyst and 0.15 g of emulsifier (commercially available under the name Belsil® DMC 3071VP from Wacker Chemie AG, D-Munich). The resulting mixture was first processed to a homogeneous emulsion, using a high-speed KPG stirrer. Then 0.14 g of water was added rapidly and emulsification took place again, to form a homogeneous mixture, using a high-speed KPG stirrer. After about 5 seconds, an exothermic reaction with development of foam began. Foam formation was over after approximately 20 seconds more, while the evolution of heat lasted for approximately 30 seconds more. This gave a grey, flexible foam which, in the flame from a Bunsen burner, proved to be incombustible and completely drip-free. When the flexible foam was exposed to the Bunsen burner flame, there was a distinct increase in volume at the point where the flame struck, resulting simultaneously in solidification of the silicone material, thereby preventing dripping.

### INVENTIVE EXAMPLE 2

### Preparation of Premix 3

50.00 g of a linear organopolysiloxane of the formula H₂N—(CH₂)₃—[(CH₃)₂—SiO]₁₂₉Si(CH₃)₂—(CH₂)₃—NH₂, in solution in a mixture of 25 ml of absolute acetone and 25 ml absolute dichloromethane, were added slowly dropwise to a solution of tolylene diisocyanate (TDI) (4.30 g in 20 ml of absolute acetone) and thus reacted at 0° C., the amino groups being fully consumed by reaction.

The resulting reaction mixture, which in addition to 51.7 g of isocyanatosiloxane OCN—(CH₂)₃—[(CH₃)₂—SiO]₁₂₉Si(CH₃)₂—(CH₂)₃—NCO also contains 2,6 TDI, was then warmed to room temperature and stirred for a further two hours, before 2.45 g of an expandable graphite (commercially available under the name “EX 180 SC” from NGS Naturgraphit GmbH, D-Leinburg) were dispersed into the solution. Subsequently premix 3 was freed from the solvent under a pressure of 10 mbar.

Using 10.00 g of the resulting premix 3, the procedure described in Inventive Example 1 was repeated.

This gave a grey, flexible foam which, in the flame from a Bunsen burner, proved to be incombustible and completely drip-free. When the flexible foam was exposed to the Bunsen burner flame, there was a distinct increase in volume at the point where the flame struck, resulting simultaneously in solidification of the silicone material, thereby preventing dripping.

### INVENTIVE EXAMPLE 3

10.00 g of premix 3 described in Inventive Example 2 were admixed with 0.16 g of bis(2-dimethylaminoethyl)ether (commercially available under the name “Jeffcat® ZF-20” from Huntsman Corp., D-Hamburg) as catalyst, 0.15 g of emulsifier (commercially available under the name Belsil® DMC 3071VP from Wacker Chemie AG, D-Munich), and 0.5 g of a hydrophobic, highly disperse silica (commercially available under the name HDK® 2000 from Wacker Chemie AG, D-Munich). The resulting mixture was first processed to a homogeneous emulsion, using a high-speed KPG stirrer. Then 0.14 g of water was added rapidly and emulsification took place again, to form a homogeneous mixture, using a high-speed KPG stirrer. After about 5 seconds, an exothermic reaction with development of foam began. Foam formation was over after approximately 20 seconds more, while the evolution of heat lasted for approximately 30 seconds more. This gave a grey, flexible foam which, in the flame from a Bunsen burner, proved to be incombustible and completely drip-free. When the flexible foam was exposed to the Bunsen burner flame, there was a distinct increase in volume at the point where the flame struck, resulting simultaneously in solidification of the silicone material, thereby preventing dripping.

1.-10. (canceled)

11. A foamable composition comprising at least one organopolysiloxane (A) having at least one isocyanate group and expandable graphite (B).

12. The composition of claim 11, wherein at least one siloxane (A) comprises units of the formula
RₐR¹_{b}(R²O)_{c}Si_{4-a-b-c/2} (I)
where
R are identical or different monovalent, SiC-bonded, optionally substituted hydrocarbon radicals optionally interrupted by oxygen atoms,
R¹ are identical or different monovalent, optionally substituted hydrocarbon radicals having at least one isocyanate group, optionally interrupted by heteroatoms,
R² are identical or different monovalent, optionally substituted hydrocarbon radicals optionally interrupted by heteoratoms,
a is 0, 1, 2 or 3,
b is 0, 1, 2 or 3, and
c is 0, 1, 2 or 3,
with the proviso that the sum a+b+c≦3 and there is present at least one unit with b other than 0.

13. The composition of claim 11, wherein expandable graphite (B) is present in an amount from 0.1 to 50 parts by weight, based on 100 parts by weight of siloxane (A).

14. The composition of claim 12, wherein expandable graphite (B) is present in an amount from 0.1 to 50 parts by weight, based on 100 parts by weight of siloxane (A).

15. The composition of claim 12, comprising
(A) one or more siloxanes comprising units of the formula (I),
(B) expandable graphite,
(C) optionally isocyanates,
(D) optionally fillers,
(E) optionally emulsifiers,
(F) optionally physical blowing agents,
(G) optionally catalysts,
(H) chemical blowing agents, and
(I) optionally, further additives.

16. The composition of claim 11, which comprises at least one chemical blowing agent (H).

17. The composition of claim 16, wherein a chemical blowing agent (H) is water.

18. A process for preparing a silicone-containing polyurethane foam, comprising reacting at least one organopolysiloxane having at least one isocyanate group (A) mixed with expandable graphite (B) with a chemical blowing agent (H).

19. The process of claim 18, comprising mixing and reacting at least one organopolysiloxane having at least one isocyanate group (A), expandable graphite (B), catalyst (G), and chemical blowing agent (H).

20. A silicone-containing polyurethane foam comprising expandable graphite, prepared from the composition of claim 11.

21. The foam of claim 20, comprising expandable graphite in an amount of from 0.05% to 30% by weight, based on the total weight of the foam.
